(19) United States
(12) Patent Application Publication
(10) Pub. No.: US 2023/0120146 A1
(43) Pub. Date: Apr. 20, 2023

(54) Runner device capable of heating the melted material by using selective radiation of electromagnetic waves

(71) Applicant: JPS CO., LTD., Gimhae-si (KR)

(72) Inventor: Dong Hoon YEO, Gimhae-si (KR)

(21) Appl. No.: 17/529,089

(22) Filed: Nov. 17, 2021

(30) Foreign Application Priority Data
Oct. 19, 2021 (KR) 10-2021-0139585

(51) Int. Cl. B22D 35/04

(52) U.S. Cl. CPC B22D 35/04

(57) ABSTRACT

The present invention relates to a runner device capable of heating a melt through selective radiating of electromagnetic waves, and the present invention comprises and discloses: a heating unit providing a path through which the melt flowing out of the melting furnace flows, and heating the melt to a predetermined temperature; a heating storage unit selectively covering the heating unit to selectively prevent thermal loss of the melt so that the melt maintains the predetermined temperature; and a radiating unit selectively provided to the heating storage unit and selectively irradiating a predetermined electromagnetic wave toward the heating unit so that the melt is at the predetermined temperature.

### TECHNICAL FIELD

The present invention relates to a runner device capable of heating a melt through selective radiating of electromagnetic waves. More specifically, the runner device minimizes the thermal loss of the melt by irradiating a predetermined electromagnetic wave to the melt and prevent the melt provided from the melting furnace from being cooled while flowing into the casting mold, and allows the melt to flow while maintaining a constant temperature.

### BACKGROUND

Casting is one of the most basic techniques of metal molding and is used to manufacture large quantities of the same shape. Casting is made by putting scrap, pig iron, ferrous alloy or non-ferrous metal raw material in a furnace, heating and melting it, pouring it into a mold of sand or metal, and cooling it. At this time, the type used for casting is called a mold, and the product made by casting is called a casting.

That is, the molten metal is poured into a mold made of the desired model, molded, and then the molten metal is solidified to become the same metal object as the model.

According to the analysis of the Korea Institute of Industrial Technology, the world's total casting production is 10.83 million tons as of 2012, and the proportion is cast iron 71.8% (72.44 million tons), cast steel 11.2% (11.3 million tons), non-ferrous castings 17.0% (17.1 million tons) is composed of Total casting production in 2012 was 10.83 million tons, an increase of 2.2% compared to 2011, and an increase of 6.0% compared to 2008. As of 2012, Korea's casting production was 2.44 million tons, the 8th largest in the world, and it occupies a 2.4% share in the global casting market. China, which is riding the rapid growth of the foundry industry, has risen to the top spot in the casting production sector after overtaking Korea in 2001. In 2012, it produced 42.5 million tons, occupying a 42.1% share of the global market. The combined share of the top five countries in casting production, such as China, the United States, India, Japan, and Germany, is 74.6%.

As an example of a related prior patent document, “ferrosilicon casting apparatus (Registration No. 10-1587280, hereinafter referred to as Patent Document 1)” exists.

In the case of the invention according to Patent Document 1, an object of the present invention is to provide a ferrosilicon casting apparatus capable of injecting most ferrosilicon into a steelmaking process. Patent Document 1 discloses a ferrosilicon casting apparatus for casting ferrosilicon used as a subsidiary material of a steelmaking process, comprising: a distributor for uniformly distributing molten ferrosilicon after being supplied through a hot water heater; a chain device that includes a front sprocket and a rear sprocket, and rotates in a ring-free track by a driving device; a plurality of mold sets that are continuously seated on the chain device and accommodate the molten ferrosilicon supplied through the distributor; a cooling device disposed on the upper surface of the chain device to cool the mold set and the ferrosilicon seated inside the mold set; and a drying device disposed on the lower surface of the chain device to cool the mold set before entering the distributor, wherein the ferrosilicon solidified inside the mold set is discharged from the entire sprocket.

As another example of a patent document, “ferrosilicon casting method (Registration No. 10-1563363, hereinafter referred to as Patent Document 2)” exists.

In the case of the invention according to Patent Document 2, an object of the invention is to provide a ferrosilicon casting method capable of injecting most of the ferrosilicon into the steelmaking process. In the invention of Patent Document 4, in the ferrosilicon casting method for casting ferrosilicon used as a subsidiary material of the steelmaking process, the molten ferrosilicon distributing step of distributing the molten ferrosilicon through a distributor through a separate melting furnace; The molten ferrosilicon distributed through the distributor is a molten ferrosilicon shape casting step of casting into a specific shape using a mold set that is continuously transferred; A ferrosilicon cooling step of cooling the ferrosilicon and the mold set through the cooling device; Casting ferrosilicon extraction step of extracting the solidified ferrosilicon from the mold set; a mold set cooling step of cooling the mold set from which ferrosilicon is extracted through a cooling device; and a drying step of drying the mold set through a drying device for moisture and cooling of the mold set surface.

As another example of a patent document, there is “an apparatus for manufacturing a ferrosilicon wire rod and a manufacturing method thereof (Registration No. 10-1994111, hereinafter referred to as Patent Document 3).”

In the case of the invention according to Patent Document 3, an apparatus for manufacturing a ferrosilicon wire rod capable of manufacturing a ferrosilicon wire rod having a size and shape suitable for input to a steelmaking process and a method for manufacturing the same are disclosed. A ferrosilicon wire rod production apparatus according to Patent Document 2 includes: a distributor for discharging and dispensing molten ferrosilicon; a transfer unit mounted on the lower side of the distributor, and for transferring the molten ferrosilicon discharged and distributed from the distributor while casting it in the form of a wire; a cooling unit mounted on the conveying unit and cooling the molten ferrosilicon wire conveyed by the conveying unit; a separation unit for separating the ferrosilicon wire cooled by the cooling unit from the transfer unit; and a cutting unit for manufacturing ferrosilicon wire pieces by cutting the ferrosilicon wire separated by the separation unit.

As another example of the patent document, “Molten material injection apparatus, casting equipment and casting method using the same (Registration No. 10-1790001, hereinafter referred to as Patent Document 4)” exists.

In the case of the invention according to Patent Document 4, it relates to a melt injection apparatus, and a casting equipment and a casting method using the same. Patent Document 4 discloses the process of providing a main mold flux; the process of pouring molten steel into the mold; preparing a molten mold flux by melting the main mold flux, and injecting the molten mold flux onto the molten steel; the process of casting slabs; and a process of determining whether to add additives according to the casting state in the process of casting the cast slab, and may improve the quality and productivity of the slab.

Existing prior art only discloses a process in which molten ferro silicon or ferro manganese is directly introduced into the mold in a molten state, and it is necessary to improve the technical element so that the molten material flows uniformly to the mold.

In addition, there is also a need for a technical element for preventing cooling in the process of inputting a steelmaking auxiliary material such as ferro silicon or ferro manganese into the mold.

### PRIOR ART LITERATURE

(Patent Document 1) Patent No. 10-1587280

(Patent Document 2) Patent No. 10-1563363

(Patent Document 3) Patent No. 10-1994111

(Patent Document 4) Patent No. 10-1790001

### SUMMARY OF THE INVENTION

The runner device capable of heating the melted material by using selective radiation of electromagnetic waves according to the present invention has been devised to solve the conventional problems as described above, and presents the following problems to be solved.

First, it is intended to transfer the melt provided from the melting furnace to the casting mold.

Second, it is intended to prevent the melt from being cooled during the flow.

Third, it is intended to irradiate a predetermined electromagnetic wave so that the melt can flow into the casting mold while maintaining a constant temperature.

The problems to be solved of the present invention are not limited to those mentioned above, and other problems not mentioned will be clearly understood by those skilled in the art from the following description.

The runner device capable of heating a melt through selective radiating of electromagnetic waves according to the present invention has the following problem solving means for the problems to be solved above.

The runner device capable of heating the melted material by using selective radiation of electromagnetic waves according to the present invention is a runner device for receiving a melt from a melting furnace and flowing it into a casting mold, the runner device comprises: a heating unit providing a path through which the melt flowing out of the melting furnace flows, and heating the melt to a predetermined temperature; a heating storage unit selectively covering the heating unit to selectively prevent thermal loss of the melt so that the melt maintains the predetermined temperature; and a radiating unit selectively provided to the heating storage unit and selectively irradiating a predetermined electromagnetic wave toward the heating unit so that the melt is at the predetermined temperature.

The heating unit of the present invention comprises a heating plate disposed adjacent to the melting furnace with one side to form a predetermined path so that the melt flowing out of the melting furnace.

The heating plate of the present invention is characterized in that: when the predetermined electromagnetic wave is selectively irradiated from the radiating unit, a predetermined heat is generated by interaction with the predetermined electromagnetic wave so that the melt is maintained at the predetermined temperature.

The heating storage unit of the present invention comprises: a thermo retention part selectively covering the heating plate by selectively forming an outer wall to surround the predetermined path formed by the heating plate so that the temperature of the melt raised to the predetermined temperature by the predetermined heat generated from the heating plate is maintained; and an insulator selectively forming an outer wall covering the thermo retention part to prevent the predetermined heat generated from the heating plate part from being diffused to the outside.

The heating storage unit of the present invention further comprises: a protecting barrier selectively covering both sides of the insulator and selectively forming a plurality of openings.

The radiating unit of the present invention comprises: a plurality of wave generators selectively disposed in the plurality of openings of the protecting barrier and generating the predetermined electromagnetic waves.

The radiating unit of the present invention further comprises a plurality of wave guiders disposed on one side of the plurality of wave generators and selectively transmitting the predetermined electromagnetic waves so that the predetermined electromagnetic waves generated from the plurality of wave generators pass through the plurality of openings and are irradiated to the heating plate.

The wave guider of the present invention is separately installed in each of the wave generators, and allow each of the wave generators to form a preset angle independently of each other.

The plurality wave guiders of the present invention are characterized in that the plurality of wave guiders are arranged to be crossed with each other, and the predetermined electromagnetic waves generated from the plurality of wave generators are selectively irradiated so as not to conflict with each other.

The radiating unit of the present invention further comprises: a cooler selectively disposed on the other side of the wave generator for cooling the predetermined heat generated from the wave generator when the predetermined electromagnetic wave is generated.

The runner device capable of heating the melted material by using selective radiation of electromagnetic waves according to the present invention having the above configuration provides the following effects.

First, it is possible to selectively radiate a predetermined electromagnetic wave in a path through which the melt passes.

Second, the predetermined heat is generated in the heating plate part by a predetermined electromagnetic wave, and the predetermined heat can be transferred to the melt.

Third, the melt flows into the casting mold while maintaining a predetermined temperature, thereby minimizing thermal loss.

Effects of the present invention are not limited to those mentioned above, and other effects not mentioned will be clearly understood by those skilled in the art from the following description.

### BRIEF DESCRIPTION OF THE DRAWING

FIG. 1 is a perspective view illustrating that the melt is provided to the runner device capable of heating the melt through selective radiating of electromagnetic waves according to an embodiment of the present invention.

FIG. 2 is a perspective view of the runner device capable of heating a melt through selective radiating of electromagnetic waves according to an embodiment of the present invention.

FIG. 3 is a perspective view of a heating unit of the runner device capable of heating a melt through selective radiating of electromagnetic waves according to an embodiment of the present invention.

FIG. 4 is a perspective view and a front perspective view of a thermo-retention part of the runner device capable of heating a melt through selective radiating of electromagnetic waves according to an embodiment of the present invention.

FIG. 5 is a perspective view of the insulator of a runner device capable of heating a melt through selective radiating of electromagnetic waves according to an embodiment of the present invention.

FIG. 6 is a perspective view of a protecting barrier of a runner device capable of heating a melt through selective radiating of electromagnetic waves according to an embodiment of the present invention.

FIG. 7 is a perspective view and a front view of the radiator of a runner device capable of heating a melt through selective radiating of electromagnetic waves according to an embodiment of the present invention.

FIG. 8 is a front view of a radiator having a preset angle of the runner device capable of heating a melt through selective radiating of electromagnetic waves according to an embodiment of the present invention.

FIG. 9 is a front perspective view showing that each predetermined electromagnetic waves does not conflict in the runner device capable of heating a melt through selective radiating of electromagnetic waves according to an embodiment of the present invention.

### DETAILED DESCRIPTION OF THE INVENTION

The runner device capable of heating a melt through selective radiating of electromagnetic waves according to the present invention can have various changes and can have various embodiments, and specific embodiments are illustrated in the drawings and described in detail in the detailed description. However, this is not intended to limit the present invention to a specific embodiment, it should be understood to include all modifications, equivalents and substitutes included in the spirit and scope of the present invention.

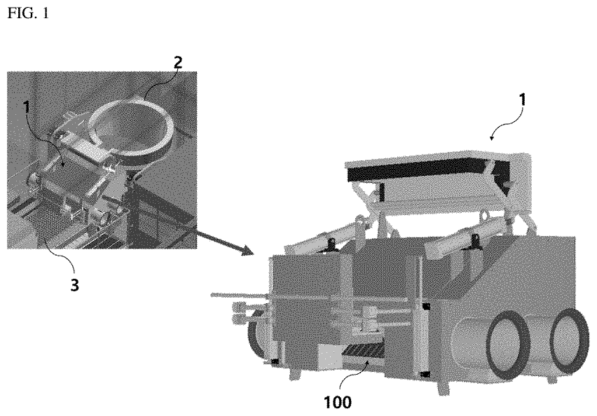

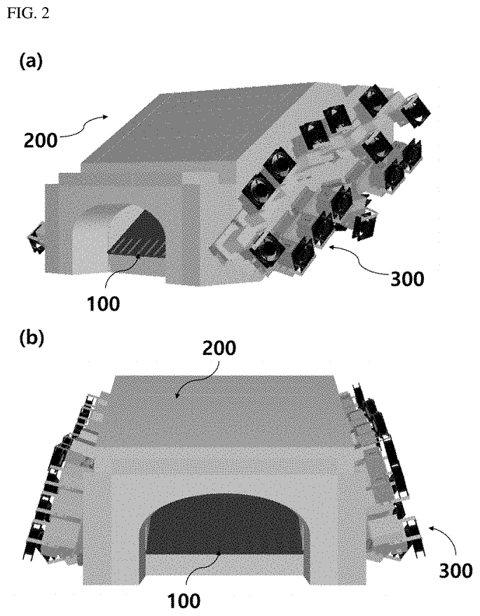

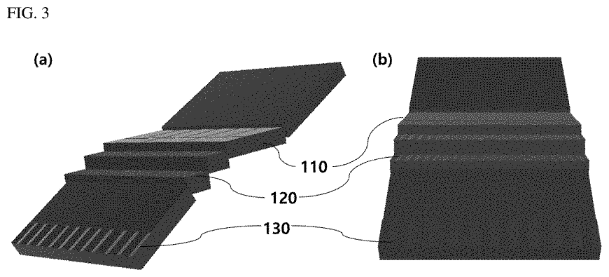

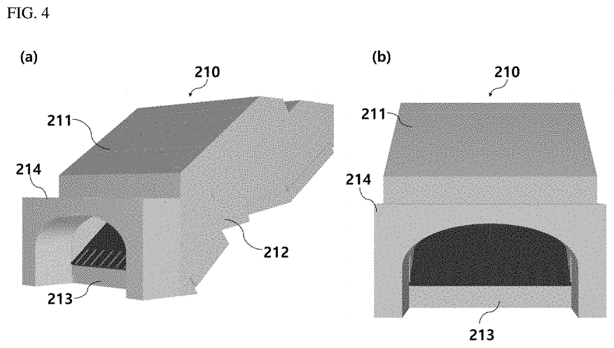

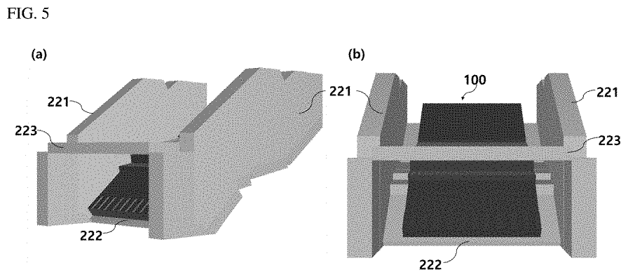

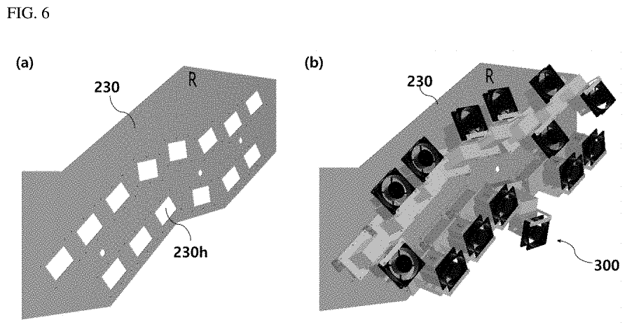

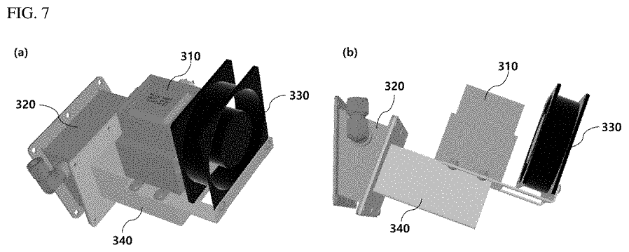

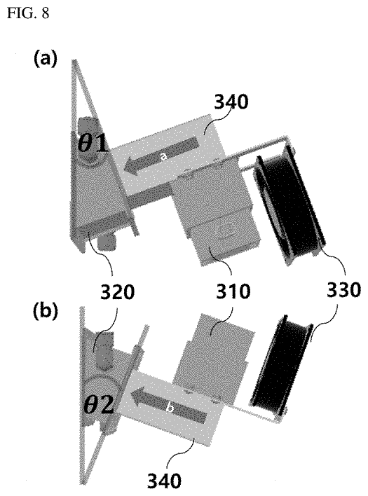

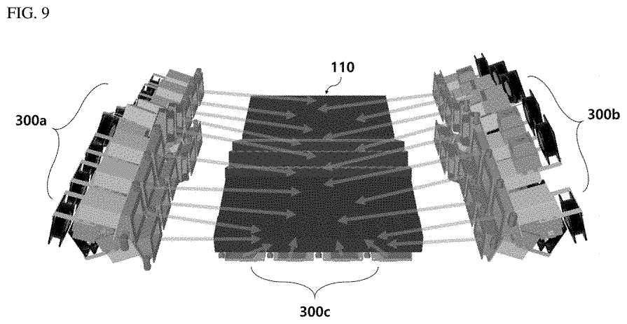

FIG. 1 is a perspective view illustrating that the melt is provided to the runner device capable of heating the melt through selective radiating of electromagnetic waves according to an embodiment of the present invention. FIG. 2 is a perspective view of the runner device capable of heating a melt through selective radiating of electromagnetic waves according to an embodiment of the present invention. FIG. 3 is a perspective view of a heating unit of the runner device capable of heating a melt through selective radiating of electromagnetic waves according to an embodiment of the present invention. FIG. 4 is a perspective view and a front perspective view of a thermo-retention part of the runner device capable of heating a melt through selective radiating of electromagnetic waves according to an embodiment of the present invention. FIG. 5 is a perspective view of the insulator of a runner device capable of heating a melt through selective radiating of electromagnetic waves according to an embodiment of the present invention. FIG. 6 is a perspective view of a protecting barrier of a runner device capable of heating a melt through selective radiating of electromagnetic waves according to an embodiment of the present invention. FIG. 7 is a perspective view and a front view of the radiator of a runner device capable of heating a melt through selective radiating of electromagnetic waves according to an embodiment of the present invention. FIG. 8 is a front view of a radiator having a preset angle of the runner device capable of heating a melt through selective radiating of electromagnetic waves according to an embodiment of the present invention. FIG. 9 is a front perspective view showing that each predetermined electromagnetic waves does not conflict in the runner device capable of heating a melt through selective radiating of electromagnetic waves according to an embodiment of the present invention.

As shown in FIG. 1, the runner device capable of heating the melted material by using selective radiation of electromagnetic waves according to the present invention is to be cast in the casting mold 3 by utilizing the runner device 1 to manufacture it in a shape of a certain unit size.

Here, Ferro-silicon or ferro-manganese is a ferro alloy used in the manufacture of steel or cast iron. Ferro-silicon is used as a deoxidizing agent and reducing agent, and is used as a graphitization accelerator in carbon steel.

In general, the melt can be made by a process of pouring directly from the melting furnace 2 to the casting mold 3 in the process of being provided from the melting furnace 2 to the casting mold 3.

In the conventional structure, the melt of the melting furnace 2 is limited to a structure in which the melt flows along the elongated pipe-shaped refractory material.

In the case of the runner device capable of heating the melted material by using selective radiation of electromagnetic waves according to the present invention, in order to prevent the melt provided from the melting furnace 2 from being cooled while flowing into the casting mold 3, a predetermined electromagnetic wave is applied to the melt for minimizing thermal loss of the melt by irradiating the melt flow while maintaining a constant temperature.

As shown in FIG. 2, the runner device capable of heating the melted material by using selective radiation of electromagnetic waves according to the present invention comprises a heating unit 100, a heating storage unit 200, and a radiating unit 300.

As shown in FIG. 3, the heating unit 100 provides a path for the melt flowing out from the melting furnace 2 to flow, and is configured to heat the melt to a predetermined temperature.

The heating unit 100 delivers the melt provided from the melting furnace 2 to the casting mold 3, and at this time, the melt is heated to a predetermined temperature by generating a predetermined heat so that the melt is not cooled, and let the temperature be maintained.

The predetermined temperature referred to herein is a temperature above the melting point or melting point of the melt, and may be defined as a temperature at which the melt is not cooled.

In addition, since the heating unit 100 is configured to receive the melt from the melting furnace 2 for the first time, it is preferable that the heating unit 100 is made of a material corresponding to heat resistance and a refractory material. Here, the heat-resistant, refractory material is an ultra-high-temperature heat-resistant material that can withstand a high temperature of several hundred to several thousand degrees (° C.), several seconds to several thousand hours, and a metal or ceramic material may be typically applied.

For example, the heating unit 100 is preferably a silicon carbide (SiC) compound in which silicon and carbon are combined in a 1:1 ratio. In addition, the heating unit 100 can generate a predetermined heat by itself as a predetermined electromagnetic wave is irradiated by utilizing the characteristics of the already commercialized silicon carbide, and a detailed mechanism thereof will be omitted.

As shown in FIG. 3, the heating unit 100 of the runner device capable of heating the melted material by using selective radiation of electromagnetic waves according to the present invention comprises a heating plate 110, a first spread part 120, and the second spread part 130.

First, one side of the heating plate 110 is disposed adjacent to the melting furnace 2 and the heating plate 110 is configured to form a predetermined path so that the melt flowing out from the melting furnace 2 is melted.

The heating plate 110 is composed of an upper part and a lower part, and the upper part forms an abrupt inclination, and one side is adjacent to the melting furnace 2 and rapidly flows the melt flowing down from the melting furnace 2. The lower part is a gentle slope and can form same strength as the horizontal surface.

The molten material can flow along an inclination from the top to the bottom of the heating plate 110.

In addition, when a predetermined electromagnetic wave is selectively irradiated from the radiating unit 300 to the heating plate 110, the predetermined heat is generated by interaction with the predetermined electromagnetic wave. The predetermined heat of the heating plate 110 may cause the melt to be maintained at a predetermined temperature.

That is, the predetermined heat of the heating plate 110 is thermally conducted to the melt, so that the melt can be at a predetermined temperature.

The first spread part 120 is stacked so that a part of it is exposed on the lower surface of the heating plate part 110, and forms wrinkles along the flow direction of the melt, so as to first disperse the falling melt.

The second spread part 130 is stacked so that a part of it is exposed on the lower surface of the first spread part 120, and forms a wrinkle opposite to the first spread part 120, so as to second disperse the falling melt from the first spread part 120.

It is preferable that the second spread part 130 forms a wrinkle opposite to that of the first spread part 120.

As shown in FIG. 2, the heating storage unit 200 selectively covers the heating unit 100 and selectively prevent thermal loss of the melt so that the melt maintains a predetermined temperature.

The heating storage unit 200 prevents heat generated by the predetermined electromagnetic wave in the heating plate unit 110 from being lost, so that the molten material can maintain a predetermined temperature.

The heating storage unit 200 forms an outer wall on the outside of the heating unit 100 in the height direction, and also forms an outer wall on the upper and lower portions to prevent heat emitted from the melt from escaping to the outside of the runner device 1, and maintains the temperature inside the unit 100 to minimize the thermal loss of the melt.

The heating storage unit 200 is preferably made of a material having heat resistance and fire resistance, for example, a fire resistant block or a heat insulating block.

The heating storage unit 200 of the runner device capable of heating the melted material by using selective radiation of electromagnetic waves according to the present invention comprises a thermo retention part 210, an insulator 220 and a protecting barrier 230.

As shown in FIG. 4, the thermo-retention part 210 selectively forms an outer wall to surround a predetermined path formed by the heating plate unit 110 and selectively covers the heating plate 110, so that the temperature of the melt raised to a predetermined temperature is maintained by the predetermined heat generated from the heating plate unit 110.

The thermo-retention part 210 includes a thermo-loop part 211, a thermo-side part 212, a thermo-floor part 213, and a thermo-arch part 214.

The thermo-loop part 211 is disposed on the upper part of the thermo-retention part 210 and cover the upper part of the heating unit 100 to maintain the temperature of the melt.

The thermo-side part 212 is disposed on both sides of the thermo-retention part 210 to cover the left and right sides of the heating unit 100 so that the temperature of the melt can be maintained.

The thermo floor unit 213 is disposed under the thermo retention unit 210 to cover the lower portion of the heating unit 100 so that the temperature of the melt can be maintained.

In the case of the thermo-arch part 214, it is disposed on the front side of the thermo-retention part 210, and is disposed adjacent to the outlet flowing from the heating unit 100 and provided to the casting mold 3, so that the temperature of the melt can be maintained in the process of that the melt is provided in the casting mold 3.

As shown in FIG. 5, the insulating unit 220 selectively forms an outer wall covering the thermo-retention part 210 and prevent a predetermined heat generated from the heating plate unit 110 from being diffused to the outside.

The insulator 220 can cover the thermo-retention part 210 covering the heating unit 100 to prevent heat from spreading to the outside.

The insulator 220 includes an insulating side part 221, an insulating floor part 222, and an insulating cross part 223.

The insulating side part 221 is disposed on both sides of the thermo-side part 212 to cover the thermo-side part 212 to prevent heat diffusion.

The insulating floor part 222 is disposed under the thermo-floor part 213 to cover the thermo-floor part 213 to prevent heat diffusion.

The insulating cross part 223 is disposed between the insulating side part 221 and covers the upper portion of the thermo-arc portion 214 to prevent heat diffusion.

As shown in FIG. 6, the protecting barrier 230 selectively covers both sides of the insulator 220 and selectively forms a plurality of openings 230h.

The protecting barrier 230 forms an outer wall on both sides of the insulator 220 in the height direction, and has a plurality of openings 230h.

In addition, the protecting barrier 230 is disposed under the insulating unit 220 in the width direction and may have a plurality of openings 230h.

A predetermined electromagnetic wave generated from the radiating unit 300 may be irradiated to the heating unit 100 through the plurality of openings 230h of the protecting barrier 230.

The plurality of openings 230h of the protecting barrier unit 230 are an entrance to which a predetermined electromagnetic wave is irradiated and are irradiated in an inward direction toward the heating unit 100. That is, the predetermined electromagnetic wave generated from the radiating unit 300 can be irradiated only through the plurality of openings 230h, and the predetermined electromagnetic wave irradiated to the heating unit 100 is to be prevented from leaking to the outside.

In addition, the protecting barrier 230 is preferably made of a metal material capable of blocking a predetermined electromagnetic wave in order to prevent the predetermined electromagnetic wave irradiated by the heating unit 100 from leaking to the outside.

As shown in FIG. 6, the radiating unit 300 is selectively provided to the heating storage unit 200, and selectively irradiates the predetermined electromagnetic wave directly toward the heating unit 100 so that the melt is at a predetermined temperature.

The radiating unit 300 of the runner device capable of heating the melted material by using selective radiation of electromagnetic waves according to the present invention comprises a wave generator 310, a wave guider 320, a cooler 330, and a bridge part 340.

As shown in FIG. 7, the wave generator 310 is selectively disposed in the plurality of openings 230h of the protecting barrier unit 230, and generates the predetermined electromagnetic wave.

The wave generator 310 could generate the predetermined electromagnetic wave by using the same or similar configuration and principle as that of a commercially available magnetron, and a detailed mechanism thereof will be omitted.

The wave guider 320, as shown in FIG. 7, is disposed on one side of the plurality of wave generators 310a. The wave guider 320 is a plurality of configurations that selectively transmit a predetermined electromagnetic wave generated from the plurality of wave generators 310 to be irradiated to the heating plate 110 through the opening 230h.

The wave guider 320 transmits a predetermined electromagnetic wave generated from the wave generator 310 to the heating unit 100.

The wave guider 320 is individually installed in each of the wave generators 310, and allows the wave generator 310 to form preset angles independently of each other.

In addition, one side and the other side of the wave guider 320 are formed at different angles so that the wave generating unit 310 can be formed at a preset angle. For example, as shown in FIG. 8, the preset angle is formed as e 1 as in FIG. 8(a), and a predetermined electromagnetic wave may be irradiated in the a direction. In addition, when the preset angle is formed as e 2 as shown in FIG. 8(b), a predetermined electromagnetic wave may be irradiated in the b direction. That is, it is possible to selectively control the direction in which a predetermined electromagnetic wave is irradiated according to a preset angle.

In addition, the plurality of wave guiders 320 are disposed to cross each other, so that each of the predetermined electromagnetic waves generated from the plurality of wave generators 310 are selectively irradiated so as not to conflict with each other.

For example, as shown in FIG. 9, when the predetermined electromagnetic wave generated from the wave generator 310 selectively present on the left, right, or lower side of the heating unit 100 is directed toward the heating unit 100, if the left and right wave generator exist symmetrically, collisions among the electromagnetic waves may occur.

At this time, when the electromagnetic waves collide, the generated collision energy may cause overall damage to the runner device 1 such as the heating unit 100, the heating storage unit 200, or the radiating unit 300 so the function of the runner device 1 is broken due to the collision.

Therefore, it is preferable that the predetermined electromagnetic waves irradiated by the plurality of wave generators 310 are arranged to be crossed with each other in order to be misaligned, that is, not to conflict with each other.

The cooler 330 is selectively disposed on the other side of the wave generator 310 to cool a predetermined heat generated from the wave generator 310 when a predetermined electromagnetic wave is generated.

For example, when the wave generator 310 generates a predetermined electromagnetic wave, heat is generated. If the generated heat continues, the wave generator 310 may fail.

Accordingly, the cooler 330 serves to cool the heat of the wave generator 310 in order to prevent failure or damage to the wave generator 310.

As shown in FIG. 7, in the case of the bridge part 340, one side of the bridge part 340 is provided to the wave guider 320, and the other side of the bridge part 340 is provided to the wave generator 310 to interconnect the wave guider 320 and the wave generator 310.

The bridge part 340 is formed to protrude from the wave guider 320 to interconnect the wave generating parts 310, and by selectively adjusting the protrusion angle of the bridge part 340, a predetermined electromagnetic wave is controlled not to collide.

The scope of the present invention is determined by the matters described in the claims, and parentheses used in the claims are not described for selective limitation, but are used for clear components, the descriptions in parentheses are also interpreted as essential components.

1. A runner device for receiving a melt from a melting furnace and flowing it into a casting mold, the runner device comprises:
a heating unit providing a path through which the melt flowing out of the melting furnace flows, and heating the melt to a predetermined temperature;
a heating storage unit selectively covering the heating unit to selectively prevent thermal loss of the melt so that the melt maintains the predetermined temperature; and
a radiating unit selectively provided to the heating storage unit and selectively irradiating a predetermined electromagnetic wave toward the heating unit so that the melt is at the predetermined temperature.

2. The runner device according to claim 1, wherein the heating unit comprises a heating plate disposed adjacent to the melting furnace with one side to form a predetermined path so that the melt flowing out of the melting furnace.

3. The runner device according to claim 2, wherein the heating plate is characterized in that:
when the predetermined electromagnetic wave is selectively irradiated from the radiating unit, a predetermined heat is generated by interaction with the predetermined electromagnetic wave so that the melt is maintained at the predetermined temperature.

4. The runner device according to claim 3, wherein the heating storage unit comprises:
a thermo retention part selectively covering the heating plate by selectively forming an outer wall to surround the predetermined path formed by the heating plate so that the temperature of the melt raised to the predetermined temperature by the predetermined heat generated from the heating plate is maintained; and
an insulator selectively forming an outer wall covering the thermo retention part to prevent the predetermined heat generated from the heating plate part from being diffused to the outside.

5. The runner device according to claim 4, wherein the heating storage unit further comprises a protecting barrier selectively covering both sides of the insulator and selectively forming a plurality of openings.

6. The runner device according to claim 5, wherein the radiating unit comprises:
a plurality of wave generators selectively disposed in the plurality of openings of the protecting barrier and generating the predetermined electromagnetic waves.

7. A method of claim 6, wherein the radiating unit further comprises a plurality of wave guiders disposed on one side of the plurality of wave generators and selectively transmitting the predetermined electromagnetic waves so that the predetermined electromagnetic waves generated from the plurality of wave generators pass through the plurality of openings and are irradiated to the heating plate.

8. The method of claim 7, wherein the wave guider is separately installed in each of the wave generators, and allow each of the wave generators to form a preset angle independently of each other.

9. The method of claim 8, wherein the plurality wave guiders are characterized in that the plurality of wave guiders are arranged to be crossed with each other, and the predetermined electromagnetic waves generated from the plurality of wave generators are selectively irradiated so as not to conflict with each other.

10. The method of claim 9, wherein the radiating unit further comprises:
a cooler selectively disposed on the other side of the wave generator for cooling the predetermined heat generated from the wave generator when the predetermined electromagnetic wave is generated.
